(19) United States
(12) Patent Application Publication
(10) Pub. No.: US 2010/0282273 A1
(43) Pub. Date: Nov. 11, 2010

(54) Machine and method for continuously washing containers made of plastic material, and removal of contaminants and labels from their surface

(75) Inventor: Piergiorgio Teruggi, Novara (IT)

Correspondence Address: HESS PATENT LAW FIRM, P.C., 9 MIRAMAR LANE, STAMFORD, CT, 06902, US

(73) Assignee: AMUT S.P.A., Novara (IT)

(21) Appl. No.: 12/681,171

(22) PCT Filed: Sep. 26, 2008
(86) PCT No.: PCT/IB08/02506

§ 371 Date: May 25, 2010

(30) Foreign Application Priority Data
Oct. 18, 2007 (EP) 07425657.9

(51) Int. Cl. B08B 9/00

(52) U.S. Cl. 134/6; 134/170

(57) ABSTRACT

A machine and a method are described for washing and removal, in a continuous manner, of contaminants and labels from plastic containers made of recyclable material. During washing, the containers pass inside a washing chamber and are subject to a high level of friction caused by an agitator rotating at high speed. Tearing means are also provided to facilitate detachment of the contaminants from the surface of the containers.

### FIELD OF THE INVENTION

The present invention concerns a machine for washing containers made of recyclable plastic, for example bottles for water, drinks or the like made of PET or other recyclable plastic materials. In particular, the present invention concerns a machine for the continuous washing of whole plastic containers or bottles and the removal of contaminants and/or plastic and paper labels from their surface.

### STATE OF THE ART

Plastic containers having one or more recyclable parts generally undergo one or more washing steps before treatment for recovery of the required recyclable plastic materials.

In the case of bottles made of PET, the known art proposes at least one pre-washing step with a heated washing fluid, if necessary together with steam at a high temperature, to remove the waste materials consisting for example of any paper or plastic labels fixed to the bottles by means of adhesives or the like.

A known example relating to a machine for continuous washing and removal of contaminants and labels from the surface of PET bottles is described in the European patent no. EP-0237127 in the name of Stamicarbon.

This document discloses a machine in which the bottles are immersed in a liquid bath heated to temperatures above 70° C. to cause melting of the glues and yielding of the PET, so as to facilitate the detachment of contaminants and plastic or paper labels, and separation of caps and any bottoms made of plastics other than PET.

Another example of a machine for pre-washing PET bottles and separating any contaminants and labels is described in the international patent application no. WO 99/55508 A1 in the name of the Applicant. The machine comprises a hollow rotating cylinder provided with a perforated lateral wall for continuous expulsion of the washing fluid, the contaminants and the labels separated from the bottles and, lastly, the single bottles. The machine also accepts bottles in the form of bales or groups and uses a washing liquid heated to a temperature of 90° C. and, if necessary, steam at high temperature.

PET bottles coated wholly or partly in PVC or PET shrink-wrap plastic sheaths or wrappers with coloured and/or printed surface have recently have been introduced onto the market. These new types of bottles, increasingly widespread, are a problem for the systems of known type which operate with a heated or high temperature washing fluid.

When heated, the shrink-wrap sheaths and wrappers tend to contract and therefore adhere more closely to the outer surface of the bottle.

If the sheaths or wrappers adhering to the bottles are not removed, the bottles themselves, although cleaned, could be discarded during the subsequent steps for automatic selection of the recyclable materials (e.g. PET) from the contaminating materials (e.g. PVC). The automatic selection is generally performed by optical systems which could interpret the bottles still covered in the sheaths as containers made of non-recyclable materials or containers that have not been thoroughly cleaned.

### SUMMARY OF THE INVENTION

The object of the present invention is to propose a machine and a method for washing plastic containers in general, and in particular bottles, and for removing any type of contaminant and/or label in a continuous manner.

A further object of the present invention is to propose a machine and a method of the type referred to above which permit reduction in the energy consumption necessary for removal of the contaminants and labels.

A further object of the present invention is to propose a machine of the type referred to above with more compact dimensions than those of the known art.

These objects are achieved by the present invention by means of a machine as claimed in claim 1 and a method as claimed in claim 18. Further characteristics of the machine and method according to the invention are described in the respective dependent claims.

According to a first aspect of the present invention, a machine is provided for the continuous washing of plastic containers and the removal of contaminants and labels from their surface, comprising: at least one fixed washing chamber having at least one inlet and one outlet for the containers; at least one agitator rotating inside the chamber and having a plurality of agitation blades; means for feeding a washing fluid into the chamber and means for expelling the washing fluid together with the contaminants and labels removed from the surface of the containers.

The machine advantageously comprises tearing means suitable for acting on the contaminants and labels adhering to the surface of the containers during their transit inside the chamber to facilitate detachment of the contaminants and labels from the surface of the containers.

The process is performed continuously, i.e. by continuously feeding the containers and the washing fluid. In the same way, the washing fluid is continuously expelled together with the contaminants and labels detached from the surface of the containers via at least one portion of perforated wall present in the washing chamber, and the clean containers without contaminants and labels are continuously extracted from the machine.

In the method according to the present invention it is particularly advantageous to maintain a high agitator speed, and therefore a high speed of the blades integral with it in rotation, to facilitate not only the action of the tearing means but also a high level of friction between the containers passing through the inside of the washing chamber.

In particular, the rotation speed of the agitator is maintained substantially constant and sufficiently high in order to guarantee that the tangential velocity of the end of the blades is higher than 2.5 m/s.

In this way, by exploiting the action of the tearing means and the high level of friction between the containers, effective removal of the contaminants and labels adhering to the surface of the containers is obtained, not only glued paper labels but also shrink-wrap plastic sheaths or wrappers, without excessively heating the washing fluid.

An aqueous solution at ambient temperature or in any case an aqueous solution that can be slightly heated to a temperature not exceeding approximately 45° C. and which can include detergent products is preferably used as a washing fluid. Said temperatures can also be reached by the fluid operating in normal working conditions without the need to provide heating units for the fluid.

According to a possible embodiment of the present invention, the tearing means include a plurality of pointed elements protruding towards the inside of the washing chamber and distributed in one or more portions of the chamber walls. Further protruding pointed elements can also be arranged on one or more blades of the agitator.

In practice, the washing consists in elimination of the typical contaminants that are normally attached to the surface of the bottles, such as paper or plastic labels, the surface dirt and remains of the content of the bottles. In addition to the above-mentioned contaminants, the machine is also able to separate any extraneous particles present among the material to be treated, for example stones, glass, plastic and metal fragments.

With respect to the existing systems proposed for this purpose, the machine according to the invention is characterised by its capability to obtain the washing result using cold water, high friction and short material washing times, while the alternative methods use hot water and long washing times with a low level of friction. By reducing the time necessary for obtaining the required level of cleaning and separation of the contaminants and labels, it is also possible to produce the washing machine with more compact dimensions than the known machines.

In short, the most evident advantages of the present invention are:
energy saving, as cold water is used instead of water heated to 90° C.;
possibility of detachment of the shrink-wrap labels, which with the known systems operating at high temperature tend to anchor even more firmly to the bottles and containers;
reduction of overall dimensions, since with the high level of friction, the container washing time is 4-5 times shorter and, consequently, the machine can be produced with more compact dimensions.

### BRIEF DESCRIPTION OF THE DRAWINGS

Further advantages and characteristics of the present invention will become more evident from the following description, provided for illustrative and non-limiting purposes, with particular reference to the accompanying schematic drawings in which:

FIG. 1 is a longitudinal section view of the washing machine according to a possible embodiment of the present invention;

FIG. 2 is an enlarged view illustrating a detail of the washing machine shown in FIG. 1; and

FIG. 3 is a cross section view along the plane III-III of the washing machine shown in FIG. 1.

### MODES FOR CARRYING OUT THE INVENTION

The washing machine according to the present invention comprises essentially a fixed washing chamber 10 with cylindrical shape, and an agitator 20 rotated inside the washing chamber 10 around an axis coinciding with that of the cylindrical chamber 10.

The embodiment shown here is intended in particular for the treatment of PET bottles, but it is evident that the same principles of the present invention can be adopted for other types of containers, as for other recyclable plastic materials.

A plurality of agitation blades 22 are arranged on the agitator, positioned so as to facilitate transit of the containers into the washing chamber 10 from an inlet 12 to an outlet 14. The containers are fed continuously via a hopper 16 and continuously extracted from the chamber 10 by means of an auger 30.

The containers are preferably fed to the washing chamber 10 at a constant mass flow rate and preferably in singularised condition, although small groups of bottles are tolerated (for example up to a maximum of approximately ten bottles).

The aqueous solution necessary for the washing process is introduced into the washing chamber 10 by means of the nozzles 15 distributed along the walls of the washing chamber 10, preferably in correspondence of the upper portion of the chamber.

The aqueous solution is introduced into the washing chamber 10 at ambient temperature, or in any case at a temperature not exceeding 45° C. To improve the washing action, chemical detergents can be added to the process water, if necessary by means of appropriate metering pumps (not shown).

A fraction of the washing fluid can also be introduced via one or more nozzles 2 supplied at pressures higher than 80 bars, for example at a pressure of around 100 bars, to provide a vigorous hydraulic action for removal of the contaminants and labels, in addition to the mechanical action exerted by the blades 22. The high pressure nozzles 2 are preferably distributed on the walls of the chamber 10 immediately upstream of the outlet 14 of the containers, or in any case in the vicinity of the same, i.e. at a potential container accumulation point before they are extracted by means of the auger 30.

The friction action between the containers is developed by the blades 22 of the agitator 20 which rotate the bodies of the plastic containers. Rubbing of the containers against one another and against the washing chamber 10 produces the vigorous action necessary for quick washing.

The agitator is operated by an electric motor 24 driven by a control unit 26. The agitator is rotated at high speed and, in particular, at a speed such that the tangential velocity measured at the end of the blades is higher than 2.5 m/s.

To increase the friction and facilitate detachment of the labels, above all of the shrink-wrap type, in the inner part of the washing chamber 10 pointed elements 41 are applied, the protrusion of which can be regulated to optimise the operation.

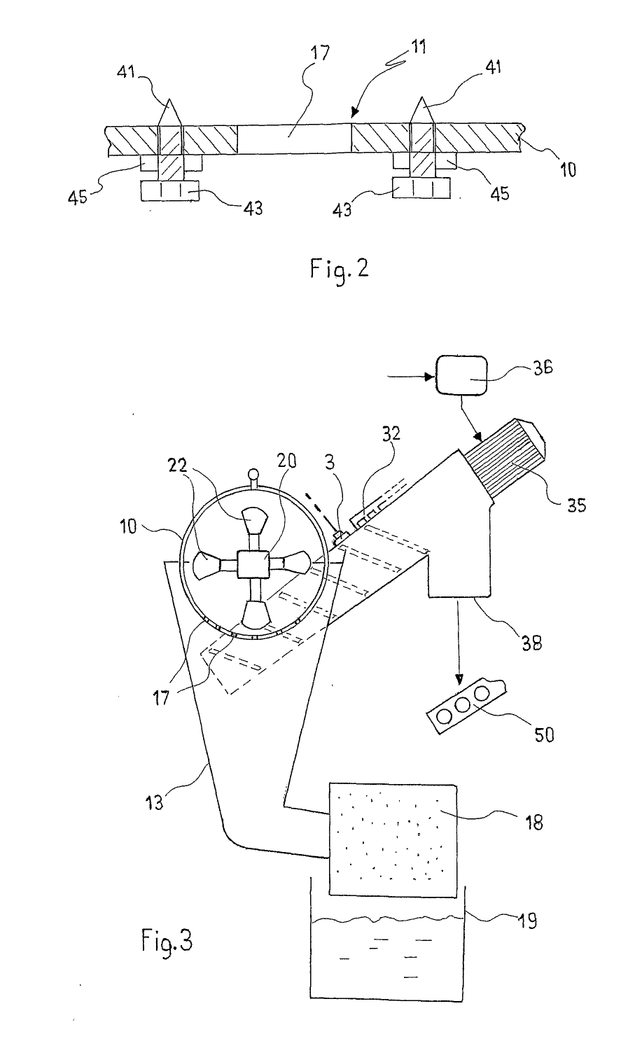

FIG. 2 shows by way of example an embodiment in which the pointed elements 41 constitute the ends of screws 43 engaged in corresponding threaded holes obtained in the wall of the washing chamber 10. A nut 45 permits adjustment of the protrusion of the pointed elements 41 towards the internal space of the washing chamber 10. The pointed elements 41 can be arranged along certain portions of the walls of the cylindrical chamber, or on one or more blades 22 of the agitator 20.

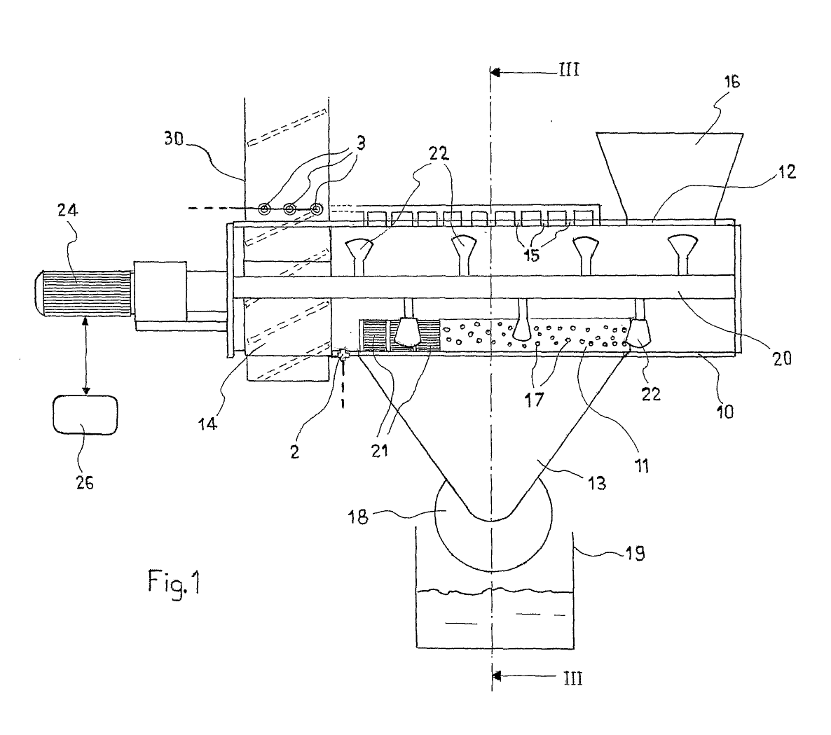

The view of FIG. 2 shows a detail of a perforated portion 11 (FIGS. 1 and 3) in the lower part of the washing chamber 10. The perforated portion 11 includes drainage holes 17 with circular section having a suitable diameter (for example approximately 50 mm) for the drainage of solid contaminants such as stones, glass etc.

In addition to the portion 11 provided with circular holes, a perforated portion 21 (FIG. 1) can also be provided having rectangular apertures delimited by a series of small cylindrical bars. These holes, or apertures, have dimensions (for example approximately 19×120 mm) such as to facilitate the passage of any plastic or paper labels already detached from the containers but with dimensions such that they cannot easily pass through the circular holes 17. The cylindrical form of the bars that delimit these apertures also facilitates expulsion of the labels and contaminants which assume a substantially flat shape once detached from the containers.

Via these circular and/or rectangular holes, the solid contaminants, the labels and the dirty aqueous solution are discharged and conveyed by a hopper 13 to a filter 18. The washing fluid separated from its solid particles is collected in a tank 19.

A fraction of the washing fluid present in the tank 19 can be withdrawn and mixed if necessary with a fraction of fresh fluid and re-introduced into the same washing chamber 10 via the nozzles 15 (FIG. 1).

The view of FIG. 3 highlights the system for extraction of the containers from the washing machine. In the continuous process carried out in the washing machine according to the present invention, due to the angle of the blades 22 of the agitator 20, the containers reach the outlet 14 where the auger 30, driven by an electric motor 35, provides for extraction of said containers.

To guarantee the material a constant stay time in the washing chamber 10 during the treatment phase, and therefore optimal filling of the chamber, the extraction auger 30 is equipped with a control unit 36.

The control unit 36 drives the motor 35 to automatically vary the extraction speed of the containers according to the current absorption measured on the motor 24 of the agitator 20. Due to this device it is possible to maintain the stay time of the containers substantially constant in the turbulent phase, so as to guarantee a constant washing result independently of the container flow rate at the machine inlet.

In other words, a certain value of the current absorbed by the motor 24 of the agitator 20 corresponds to a certain filling level of the washing chamber 10. Therefore, according to the settings of the control unit 36, the extraction auger 30 modulates its speed to maintain constant the effort required by the agitator 20. The result is that, while working continuously, it is possible to maintain the required filling level of the washing chamber 10 which determines the stay time of the containers during treatment in the chamber.

The renewal of at least part of the washing fluid necessary to maintain the level of contamination in the washing chamber 10 constant can also be performed by means of a shower 32 provided with nozzles directed onto the containers extracted by the auger 30. In this case the fluid comes from the stages downstream, in which the level of contamination of the recovered fluid is lower than that of the washing fluid in the chamber 10.

The containers extracted by means of the auger 30 pass through the outlet 38 of the same and are directed to subsequent treatment steps, for example to a further step of separation between the contaminants, including any remaining labels, and the containers performed by means of at least one ballistic screen 50.

The auger 30 can also be provided with high pressure nozzles 3, supplied at pressures above 80 bars (for example 100 bars). Also in this case, the high pressure nozzles 3 are arranged in a favourable position to exert a vigorous hydraulic action for removal of the contaminants and labels, i.e. in a position in which the containers have limited freedom of movement.

Both the nozzles 2 arranged on the chamber 10 and the nozzles 3 arranged on the auger 30 can be supplied with fresh fluid able to restore at least partly the overall fluid content constantly present in the chamber 10, leaving the nozzles 15, and also 32 if necessary, the job of restoring the fraction of filtered and purified fluid coming, for example, from the tank 19.

Various modifications can be made to the embodiments represented here without departing from the scope of the present invention. For example, the tearing means can have a different shape from the pointed elements 41 of the screws 43, and systems can be provided to simultaneously adjust the protrusion of all the pointed elements in one single operation, both on the walls of the chamber 10 and on the blades 22. In the same way, the control units 26 and 36, even if shown for the sake of clarity as separate units, can be integrated in one single main control unit which controls other functions of the machine or plant in which it is installed.

1. A machine for the continuous washing of plastic containers and the removal of contaminants and labels from their surface, comprising:
at least one fixed washing chamber having at least one inlet and one outlet for said containers;
at least one agitator rotated inside said chamber and having a plurality of agitation blades;
means for supplying a washing fluid inside said chamber;
and means for expelling said washing fluid together with the contaminants and labels removed from the surface of said containers,
characterised by comprising tearing means suitable for acting on the contaminants and labels adhering to the surface of said containers during their transit inside said chamber to facilitate detachment of the contaminants and labels from the surface of said containers.

2. The machine as claimed in claim 1, wherein said tearing means include a plurality of pointed elements protruding towards the inside of said washing chamber and distributed in one or more portions of the walls of said chamber.

3. The machine as claimed in claim 1, wherein said tearing means include a plurality of pointed elements protruding from one or more blades of said agitator.

4. The machine as claimed in claim 2, wherein a protruding level of said pointed elements with respect to their fixing surface is adjustable.

5. The machine as claimed in claim 1, wherein said means for expelling said washing fluid together with the contaminants and labels removed from the surface of said containers is configured and arranged to carry out the expelling in a continuous manner and includes at least one perforated portion of the walls of said washing chamber.

6. The machine as claimed in claim 5, wherein said at least one perforated portion includes circular section holes.

7. The machine as claimed in claim 5, wherein said at least one perforated portion includes holes with a substantially rectangular section.

8. The machine as claimed in claim 1, wherein said agitation blades are directed so as to facilitate the transit of said containers from said inlet to said outlet.

9. The machine as claimed in claim 1, wherein said means for supplying a washing fluid inside said chamber include a plurality of nozzles distributed along the walls of said chamber.

10. The machine as claimed in claim 1, wherein said means for supplying a washing fluid inside said chamber include at least one nozzle positioned on the wall of said chamber and supplied at a pressure greater than 80 bars.

11. The machine as claimed in claim 1, wherein said washing fluid consists of an aqueous solution kept at a temperature below 45° C.

12. The machine as claimed in claim 1, wherein said washing fluid consists of an aqueous solution that includes chemical detergent products.

13. The machine as claimed in claim 1, wherein an electric motor is provided to drive said agitator, and wherein control means are provided to rotate said agitator at a speed such as to obtain a tangential velocity, measured at the end of said blades, greater than 2.5 m/s.

14. The machine as claimed in claim 1, wherein an extraction auger is provided in correspondence of the outlet for said containers.

15. The machine as claimed in claim 14, wherein an electric motor is provided to drive said extraction auger, and wherein control means are provided to regulate the extraction speed of said containers from said washing chamber.

16. The machine as claimed in claim 14, wherein said means for supplying a washing fluid inside said chamber include a plurality of nozzles distributed on said extraction auger.

17. The machine as claimed in claim 14, wherein said means for supplying a washing fluid inside said chamber include at least one nozzle positioned on said extraction auger and supplied at a pressure greater than 80 bars.

18. A method for continuous washing of plastic containers and the removal of contaminants and labels from their surface, which includes the steps of:
feeding said containers to a washing chamber via an inlet;
rotating at least one agitator having a plurality of agitation blades inside said washing chamber;
supplying a washing fluid inside said chamber;
extracting said containers from said washing chamber via an outlet of said chamber; and
expelling said washing fluid together with the contaminants and labels removed from the surface of said containers,
characterised by providing for the surface tearing of the contaminants and labels adhering to the surface of said containers during their transit inside said chamber to facilitate detachment of the contaminants and labels from the surface of said containers.

19. The method as claimed in claim 18, wherein the tearing is performed by a plurality of pointed elements protruding towards the inside of said washing chamber and distributed in one or more portions of the walls of said chamber.

20. The method as claimed in claim 18, wherein the tearing is performed by a plurality of pointed elements protruding from one or more blades of said agitator.

21. The method as claimed in claim 19 further comprising adjusting a protruding level of said pointed elements with respect to their fixing surface.

22. The method as claimed in claim 18, wherein said expelling of the washing fluid together with the contaminants and labels removed from the surface of said containers is performed in a continuous manner via a perforated portion of the walls of said washing chamber.

23. The method as claimed in claim 18, further comprising directing said agitation blades so as to facilitate the transit of said containers from said inlet to said outlet.

24. The method as claimed in claim 18, wherein said supplying of the washing fluid into said chamber is via a plurality of nozzles distributed along the walls of said chamber.

25. The method as claimed in claim 18, wherein said supplying of the washing fluid into said chamber is via at least one nozzle positioned on the wall of said chamber and supplied at a pressure greater than 80 bars.

26. The method as claimed in claim 18, wherein said washing fluid consists of an aqueous solution kept at a temperature below 45° C.

27. The method as claimed in claim 18, wherein said washing fluid consists of an aqueous solution that includes chemical detergent products.

28. The method as claimed in claim 18, further comprising driving said at least one agitator by an electric motor to effect the rotating of the at least one agitator, and wherein said rotating of the at least one agitator is at a speed such as to obtain a tangential velocity, measured at the end of said blades, greater than 2.5 m/s.

29. The method as claimed in claim 18, further comprising extracting said containers from the washing chamber by means of an extraction auger positioned in correspondence of said outlet.

30. The method as claimed in claim 29, further comprising driving wherein said extraction auger by an electric motor to effect the extracting, and regulating an extraction speed of said containers from said washing chamber by suitable control means.

31. The method as claimed in claim 29, wherein said supplying of the washing fluid into said chamber is via a plurality of nozzles distributed on said extraction auger.

32. The method as claimed in claim 29, wherein said supplying of the washing fluid into said chamber is via at least one nozzle positioned on said extraction auger and the supplying of the washing fluid is at a pressure greater than 80 bars.

33. The method as claimed in claim 18, wherein said feeding of said containers to the washing machine is at a constant mass flow rate.

34. The method as claimed in claim 18, wherein said feeding of said containers to the washing machine is in singularised condition.

35. The method as claimed in claim 18, wherein the supplying of the washing fluid to said machine includes expelling a fraction of the fluid after the fluid has been at least filtered to separate the contaminants and the labels removed from the surface of said containers.

36. The method as claimed in claim 18, wherein said plastic containers include PET bottles.

37. The method as claimed in claim 20, further comprising adjusting a protruding level of said pointed elements with respect to their fixing surface.

38. The machine as claimed in claim 3, wherein a protruding level of said pointed elements with respect to their fixing surface is adjustable.
